(19) United States
(12) Patent Application Publication
(10) Pub. No.: US 2011/0041346 A1
(43) Pub. Date: Feb. 24, 2011

(54) CHISEL WITH INTERCHANGEABLE BLADE

(76) Inventor: Kun-Chen CHEN, Taichung Hsien (TW)

Correspondence Address: PATENTTM.US, P. O. BOX 82788, PORTLAND, OR, 97282-0788, US

(21) Appl. No.: 12/545,947

(22) Filed: Aug. 24, 2009

(51) Int. Cl. B25D 3/00; B25D 17/04; B25D 17/08

(52) U.S. Cl. 30/167; 30/337

(57) ABSTRACT

A chisel with interchangeable blade has a handle, a holding device and a blade. The handle has two ends and a device hole. The device hole is defined in one end of the handle. The holding device is securely mounted in the device hole and has a body. The body is securely mounted in and protrudes out from the device hole and has a connecting end and a connecting hole. The connecting end protrudes out from the device hole. The connecting hole is defined in the connecting end of the body and has a cross section. The blade is detachably mounted on the holding device and has a connecting tang. The connecting tang is detachably mounted in the connecting hole and has a cross section corresponding to that of the connecting hole.

### BACKGROUND OF THE INVENTION

1. Field of the Invention

The present invention relates to a hand tool for shaping wood, and more particularly to a chisel with interchangeable blade.

2. Description of Related Art

A conventional chisel comprises a handle, a butt and a blade. The handle has two ends. The butt is mounted securely on and protrudes out from one end of the handle. The blade has a tang securely mounted in the other end of the handle. In use, the handle is held by a user and the blade is placed on a working surface. The butt is then struck to carve the working surface.

However, in use, different blades are required from roughing out through completion so many chisels must be carried, which is inconvenient and reduces portability. Further, due to multi impacts, the butt may loosen and be damaged or fall from the handle requiring replacement of the chisel.

To overcome the shortcomings, the present invention tends to provide a chisel with interchangeable blade to mitigate or obviate the aforementioned problems.

### SUMMARY OF THE INVENTION

The main objective of the invention is to provide a chisel with interchangeable blade allowing various blades to be interchanged in the same handle.

A chisel with interchangeable blade has a handle, a holding device and a blade. The handle has two ends and a device hole. The device hole is defined in one end of the handle. The holding device is securely mounted in the device hole and has a body. The body is securely mounted in and protrudes out from the device hole and has a connecting end and a connecting hole. The connecting end protrudes out from the device hole. The connecting hole is defined in the connecting end of the body and has a cross section. The blade is detachably mounted on the holding device and has a connecting tang. The connecting tang is detachably mounted in the connecting hole and has a cross section corresponding to that of the connecting hole.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a chisel with interchangeable blade in accordance with the present invention;

FIG. 2 is a perspective view of the chisel with interchangeable blade in FIG. 1, shown with blade removed;

FIG. 3 is a side view in partial section of the chisel with interchangeable blade in FIG. 1;

FIG. 4 is an operational view of the chisel with interchangeable blade in FIG. 1; and

FIG. 5 is a perspective view of the chisel with interchangeable blade in FIG. 1 showing attachment of a different size blade.

### DETAILED DESCRIPTION OF PREFERRED EMBODIMENT

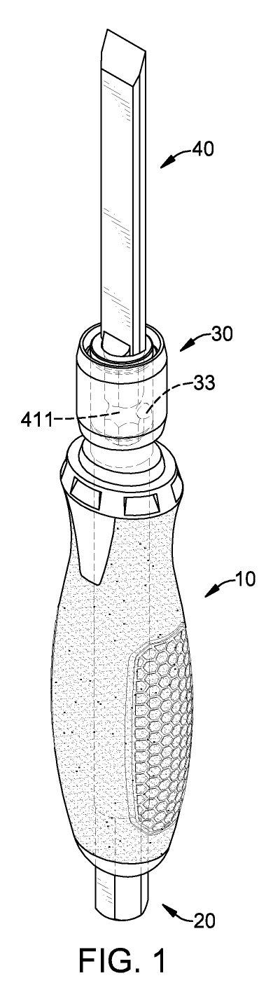

With reference to FIG. 1, a chisel with interchangeable blade in accordance with the present invention comprises a handle (10), a core (20), a holding device (30) and a blade (40).

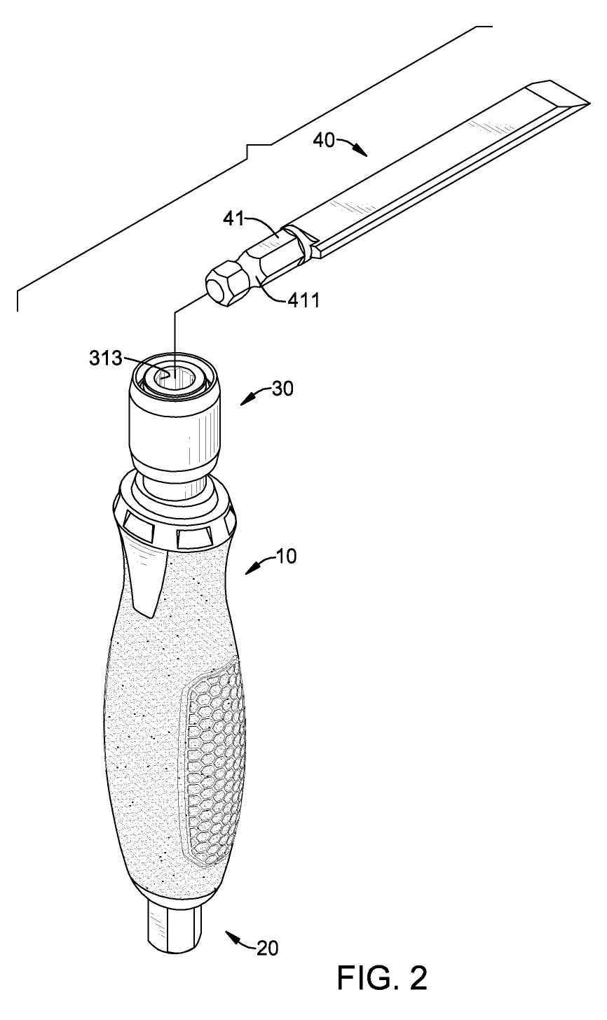

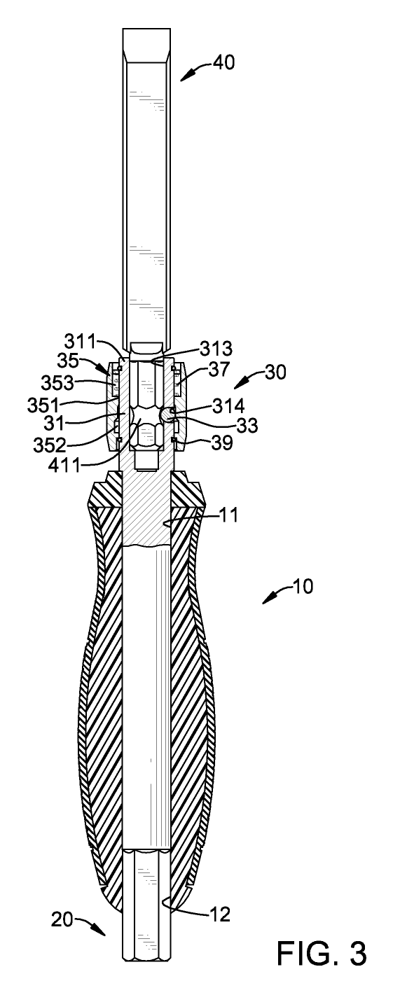

With further reference to FIGS. 2 and 3, the handle (10) has two ends, a device hole (11) and a core hole (12). The device hole (11) is defined in one end of the handle (10). The core hole (12) is defined in the other end of the handle (10). Preferably, the core hole (12) aligns and communicates with the device hole (11).

The core (20) is solid and metal, is securely mounted in the core hole (12) and protrudes out from the core hole (12) to be struck.

The holding device (30) is securely mounted in the device hole (11) and has a body (31), a holding ball (33), a sliding sleeve (35), a spring (37) and two C-shaped rings (39). The body (31) is securely mounted in and protrudes out from the device hole (11). Preferably, the body (31) is connected integrally to the core (20) to form the body (31) and the core (20) as a single part, so structural strength of the core (20) is enhanced to bear impacts from hammering. The body (31) has a connecting end (311), a connecting hole (313) and a ball hole (314). The connecting end (311) protrudes out from the device hole (11). The connecting hole (313) is defined in the connecting end (311) of the body (31) and has a cross section. The cross section of the connecting hole (313) is noncircular. Preferably, the cross section of the connecting hole (313) is hexagonal. The ball hole (314) is radially defined through the body (31) and communicates with the connecting hole (313). The holding ball (33) is retractably mounted in the ball hole (314) and protrudes into the connecting hole (313).

The sliding sleeve (35) is slidably mounted around the connecting end (311) of the body (31) to push the holding ball (33) to partially protrude into the connecting hole (311) and to allow the holding ball (33) to retract from the connecting hole (311). The sliding sleeve (35) has an inner surface, an abutting flange (351), a ball groove (352) and a spring groove (353). The abutting flange (351), the ball groove (352) and the spring groove (353) are annular and are defined in sequence around the inner surface of the sliding sleeve (35). The abutting flange (351) abuts the holding ball (33). The ball groove (352) can provide space to hold the holding ball (33) when the sliding sleeve (35) is slid and the ball groove (352) aligns with the ball hole (314). The spring (37) is mounted around the connecting end (311) of the body (31) and is compressibly mounted in the spring groove (353) to hold the sliding sleeve (35) and to push the sliding sleeve (35) back to its original position when the sliding sleeve (35) is released. The C-shaped rings (39) are mounted securely around the connecting end (311) of the body (31) to limit a movement range of the sliding sleeve (35) relative to the connecting end (311) of the body (31).

The blade (40) is detachably mounted in the holding device (30) and has a connecting tang (41). The connecting tang (41) is detachably mounted in the connecting hole (313) and has a cross section and an engaging recess (411). The cross section of the connecting tang (41) is noncircular and corresponds to that of the connecting hole (313). Preferably, the cross section of the connecting tang (41) is hexagonal. The engaging recess (411) is annular and is defined around the connecting tang (41) and detachably engages the holding ball (33). With engagement of the engaging recess (411) and the holding ball (33), the blade (40) can be securely connected to the holding device (30).

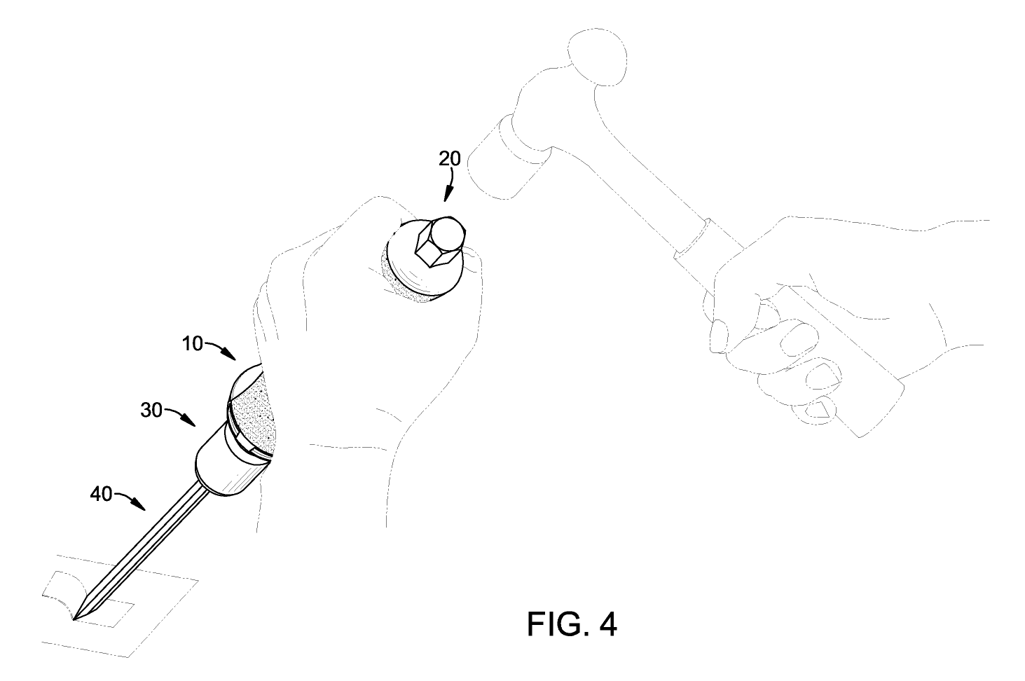

With further reference to FIG. 4, while in use, the handle (10) is held and the blade (40) is placed on a working surface. The core (20) is then struck to carve by using the blade (40).

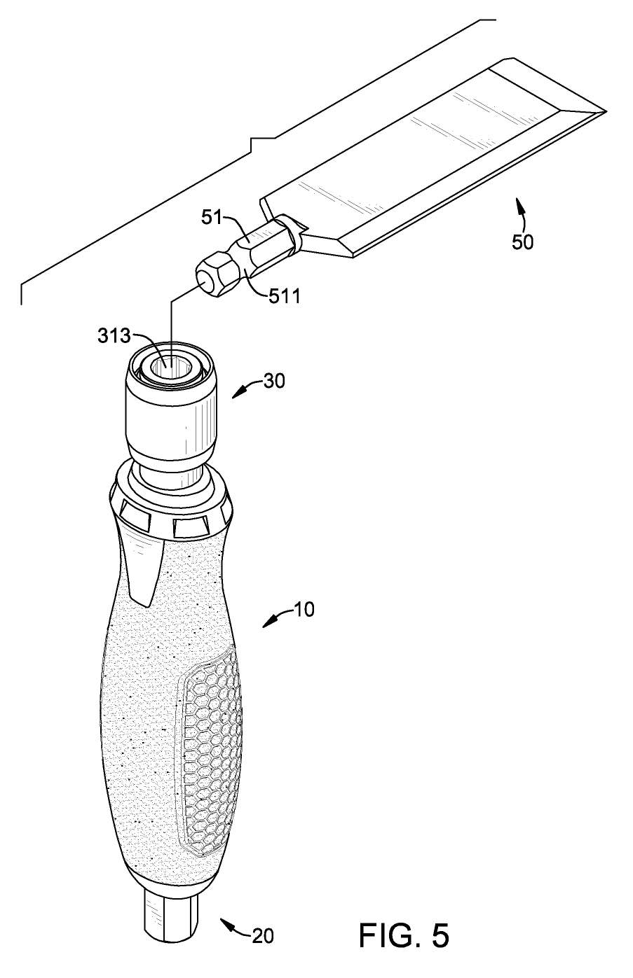

With further reference to FIG. 5, for replacement, the sliding sleeve (35) is pushed toward the blade (40) to compress the spring (37). And then the ball groove (352) aligns with the ball hole (314) to allow the holding ball (33) to slide into the ball groove (352). Therefore, the holding ball (33) cannot engage the engaging recess (411) so the blade (40) can be pulled away from the connecting hole (313). Moreover, a different size of blade (50) has the same connecting tang (51) and engaging recess (511) as the blade (40) and is inserted into the connecting hole (313). The compressed spring (37) will push the sliding sleeve (35) back into the original position when the sleeve (35) is released. Consequently, the holding ball (33) is pushed by the abutting flange (351) to engage the engaging recess (511). Therefore, various blades (40,50) may be interchanged for improved convenience of use.

From the above description, it is noted that the invention has the following advantages:

1. Replaceable blade (40,50):

Because of engagement of the holding ball (33) and the engaging recess (411), various blades (40,50) may be inserted and fixed in the connecting hole (313).

2. Reduced volume:

Because various blades (40,50) share the same handle (10), volume of the chisels can be greatly reduced and be easily portable.

3. Enhanced structural strength of the core (20):

Structural strength of the core (20) is enhanced because the core (20) is connected integrally to the body (31) to form the body (31) and the core (20) as a single part. This ensures the core (20) does not loosen or fall from the handle (10).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chisel with interchangeable blade comprising:
a handle having
two ends; and
a device hole defined in one end of the handle;
a holding device securely mounted in the device hole and having
a body securely mounted in and protruding out from the device hole and having
a connecting end protruding out from the device hole; and
a connecting hole defined in the connecting end of the body and having a cross section; and
a blade detachably mounted in the holding device and having
a connecting tang detachably mounted in the connecting hole and having a cross section corresponding to that of the connecting hole.

2. The chisel as claimed in claim 1, wherein
the body further has
a ball hole radially defined through the body and communicating with the connecting hole;
the holding device further has
a holding ball retractably mounted in the ball hole and protruding into the connecting hole; and
a sliding sleeve slidably mounted around the connecting end of the body and having
an inner surface; and
an annular ball groove defined around the inner surface of the sliding sleeve to provide space to hold the holding ball when the sliding sleeve is slid and the ball groove aligns with the ball hole; and
the connecting tang further has
an annular engaging recess defined around the connecting tang and detachably engaging the holding ball.

3. The chisel as claimed in claim 2, wherein
the sliding sleeve further has
an annular spring groove defined around the inner surface of the sliding sleeve beside the ball groove; and
the holding device further has
a spring mounted around the connecting end of the body and compressibly in the spring groove.

4. The chisel as claimed in claim 3, wherein
the holding device further has
two C-shaped rings mounted securely around the connecting end of the body to limit a movement range of the sliding sleeve relative to the connecting end of the body.

5. The chisel as claimed in claim 1, wherein
the handle further has
a core hole defined in the other end of the handle; and
a core securely mounted in the core hole and protrudes out from the core hole.

6. The chisel as claimed in claim 2, wherein
the handle further has
a core hole defined in the other end of the handle; and
a core securely mounted in the core hole and protrudes out from the core hole.

7. The chisel as claimed in claim 3, wherein
the handle has
a core hole defined in the other end of the handle; and
a core securely mounted in the core hole and protrudes out from the core hole.

8. The chisel as claimed in claim 4, wherein
the handle has
a core hole defined in the other end of the handle; and
a core securely mounted in the core hole and protrudes out from the core hole.

9. The chisel as claimed in claim 5, wherein
the core hole aligns with and communicates with the device hole; and
the body is connected integrally to the core to form the body and the core as a single part.

10. The chisel as claimed in claim 6, wherein
the core hole aligns with and communicates with the device hole; and
the body is connected integrally to the core to form the body and the core as a single part.

11. The chisel as claimed in claim 7, wherein
the core hole aligns with and communicates with the device hole; and
the body is connected integrally to the core to form the body and the core as a single part.

12. The chisel as claimed in claim 8, wherein
the core hole aligns with and communicates with the device hole; and
the body is connected integrally to the core to form the body and the core as a single part.

13. The chisel as claimed in claim 1, wherein
the cross section of the connecting hole is hexagonal.

14. The chisel as claimed in claim 2, wherein
the cross section of the connecting hole is hexagonal.

15. The chisel as claimed in claim 3, wherein
the cross section of the connecting hole is hexagonal.

16. The chisel as claimed in claim 4, wherein
the cross section of the connecting hole is hexagonal.

17. The chisel as claimed in claim 5, wherein
the cross section of the connecting hole is hexagonal.

18. The chisel as claimed in claim 6, wherein
the cross section of the connecting hole is hexagonal.

19. The chisel as claimed in claim 7, wherein
the cross section of the connecting hole is hexagonal.

20. The chisel as claimed in claim 8, wherein
the cross section of the connecting hole is hexagonal.
